(19) United States
(12) Patent Application Publication
(10) Pub. No.: US 2014/0166703 A1
(43) Pub. Date: Jun. 19, 2014

(54) LIQUID SPICE SUPPLY APPARATUS OF A COOKING GUIDE SYSTEM LINKED WITH THE INTERNET

(71) Applicant: Ho Lee, Siheung-si Kyeonggi-do (KR)

(72) Inventor: Ho Lee, Siheung-si Kyeonggi-do (KR)

(21) Appl. No.: 13/823,528

(22) PCT Filed: Sep. 14, 2011
(86) PCT No.: PCT/KR11/06762

§ 371 Date: May 1, 2013

(30) Foreign Application Priority Data
Sep. 17, 2010 (KR) 10-2010-0091335

(51) Int. Cl. B05B 7/00

(52) U.S. Cl. CPC A47J 43/04
USPC 222/630

(57) ABSTRACT

The present invention relates to a liquid spice supply apparatus of a cooking guide system linked with the internet. The cooking guide system, including a digital chef provided by updating recipe information and an automatic spice supply part for storing spices and automatically supplying the spices to the outside, comprises: an air pump installed on the digital chef; a solenoid valve connected to the air pump to change a direction of supplied air; a plurality of spice containers connected to the solenoid valve to receive air and storing liquid spice; and a discharge hose pass through the liquid spice containers to discharge the liquid spice by means of the air supplied into the spice containers, wherein the liquid spice is supplied to the outside. Thus, the liquid spice stored in the liquid spice container may be supplied at more exact and precise amounts. Therefore, since an accurate amount of spice is supplied according to the provide recipe information and the number of portions, taste may always be uniformly maintained.

### BACKGROUND OF THE INVENTION

1. Field of the Invention

The present invention relates to a cooking guide system linked with the internet, more particularly to a liquid spice supply apparatus of a cooking guide system linked with the internet, which is able to supply a more accurate and precise amount of liquid spice stored in a digital chef, an guide system, which makes anybody cook a food of a relevant recipe easily by exchanging various recipe information through the internet.

2. Description of the Related Art

In the families of recent modern society, Couples who work together for a living and singles are increasing.

Especially in the case of both working couples, they eat out more due to a shortage of time. Due to the settlement of the culture of eating out, taste buds accustomed to the taste of food provided by an expert chef quality, but the food cannot be cooked at home because of the absence of the food information.

Many professional chefs provide own know-how through the books of disclosed cooking or the Internet personal blogs, which are often used for cooking at home. However, people usually cook through own experience or presumption because cooking information is rough and does not provide precise information according to the number of servings. Therefore, there is a problem that people cannot cook like the cooking information provided at the books or the Internet.

In addition, the cooking information through the books or the Internet has much discomfort and disadvantage that food can be exposed to the environment at which food is easily contaminated with the bacteria because people have to continue to find the books or the Internet during cooking.

Thus, the present inventor developed a digital chef but more accurate and precise dispensing of seasoning was required in order to flavor close to the cooking information.

### SUMMARY OF THE INVENTION

The present invention is contrived to solve former problems. A discharge apparatus supplies a more accurate and precise amount of liquid spice stored at a digital chef so that a more accurate amount of spice is discharged according to provided cooking information and the number of servings. As a consequence, the same taste can always be replicated for a certain dish.

### BRIEF DESCRIPTION OF THE DRAWINGS

FIG. 1 shows a detailed diagram of an Internet-linked cooking assistant system applied in the present invention.

FIG. 2 shows an outside view of a digital chef in the cooking assistant system applied in the present invention.

FIG. 3 shows an inside view of a digital chef, of which the case is removed, applied in the present invention.

FIG. 4 shows a outlined diagram of a liquid spice supply apparatus in a digital chef applied in the present invention.

FIG. 5 shows an installing state of a liquid spice supply apparatus in a digital chef applied in the present invention.

### DETAILED DESCRIPTION OF THE INVENTION

The cooking guide system linked with the internet, including a digital chef provided by updating recipe information and an automatic spice supply part for storing spices and automatically supplying the spices to the outside, comprises: an air pump installed on the digital chef; a solenoid valve connected to the air pump to change a direction of supplied air; a plurality of spice containers connected to the solenoid valve to receive air and storing liquid spice; and a discharge hose pass through the liquid spice containers to discharge the liquid spice by means of the air supplied into the spice containers, wherein the liquid spice is supplied to the outside.

And output ports more than liquid spice containers are installed at the solenoid valve. The air pump, the solenoid valve and the liquid spice containers are connected by flexible hose. It is preferred that the discharge hose is installed close to the bottom of the liquid spice container.

### EFFECTS

The liquid spice discharge apparatus of for a cooking guide system linked with internet of the present invention can be effective to replicate the same taste always for a certain dish because a precise amount of liquid spice can be discharged according to provided cooking information and the number of servings by being able to supply a more accurate amount of spice stored in a liquid spice container.

According to the present invention, liquid spice is discharged by the amount of incoming air into a liquid spice container so that an accurate amount of spice can be discharged.

### DESCRIPTION OF THE PREFERRED EMBODIMENTS

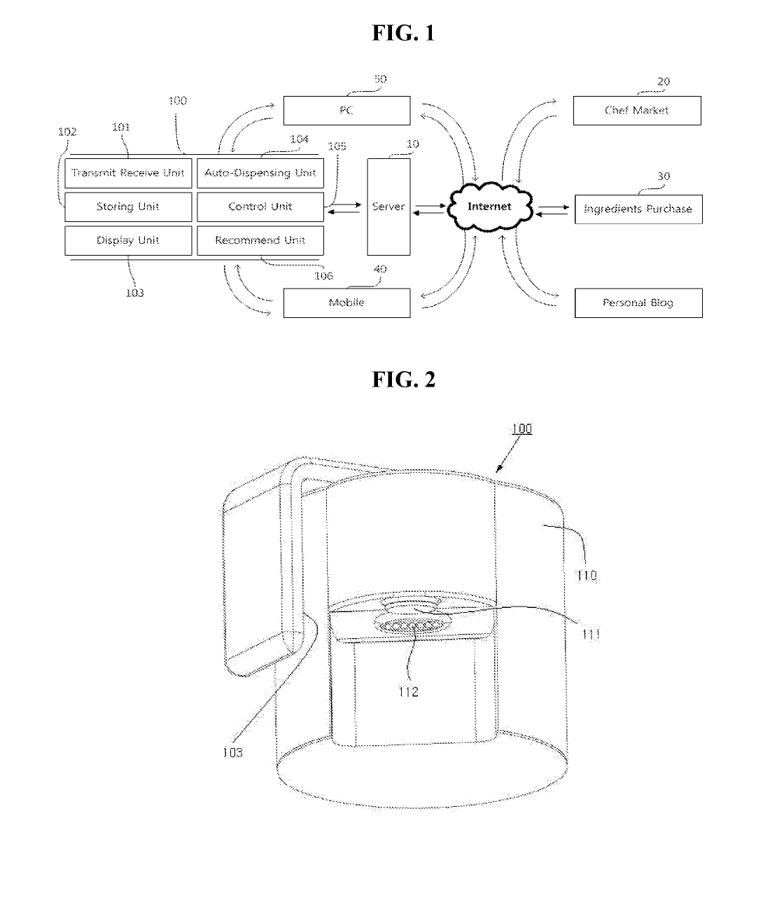

The cooking guide system linked with internet and the liquid discharge apparatus according to the present invention are illustrated in FIGS. 1 and 5.

First, the cooking guide system linked with the internet, as illustrated in FIG. 1, comprises a digital chef (100); a cooking assistant apparatus, a server (10), a PC (50), a mobile (40), a chef market (20) and partners market (30).

A digital chef (100), a server (10), a PC (50), a mobile (40), a chef market (20) and a partners market (30) are connected with each other directly or indirectly so that various recipes information can be exchanged. In other words, various recipes can be updated or downloaded. The recipe information is meant by overall information such as main ingredients, the number and weight of main ingredients, the kinds and amount of seasoning, the order of adding seasoning, cooking method like cooking time and cooking temperature, number of servings and a category belonged to by the recipe information.

The server (10) exchanges various recipes information continuously over internet, storage media, such as flash memory, card memory and removable hard disk drive, or transmission media like a transmission method using public communications network. In other words, the server (10) stores or downloads updated information by exchanging various recipes through a digital chef (100), a server (10), a PC (50), a mobile (40), a chef market (20) and a partners market (30). Therefore, the server (10) can use various functions and contents of internet site, recipes can be real time updated and downloaded, and data can be transmitted and received.

The mobile (40) can get information about recipes by transmitted data such as text, image, video and encoded data from the digital chef (100), and my recipes inversely can be added and provided to the digital chef (100) through the mobile (40). Such the mobile (40) can be interlocked with not only the digital chef (100) but also the server (10) like the digital chef (100) noted above.

The PC (50) can store data, interlocked with the digital chef (100) and storage media such as flash memory and removable hard disk drives, and data can be provided to the digital chef (100) through the PC (50) inversely. Such the PC (50) can be interlocked with not only a digital chef (100) and storage media but also the server (10) as noted above.

The digital chef (100) can exchange various recipes information, connected with a PC (50), a mobile (40), a chef market (20), a partners market site (30) besides a server (10), and provides relevant recipes information visually, acoustically and audiovisually, meanwhile, and also dispenses seasoning automatically according to a recipe information from a state stored as type.

The digital chef (100) comprises a transmission and reception unit (101), a storage unit (102), a display unit (103), an automatic seasoning dispensing unit (104), a control unit (105), and a recommendation unit (106).

The transmission and reception unit (101) plays a role of transmission and reception recipes information with the server (10). It provides a user with recipe information received from the server (10) and transmits a user's inputting own recipe information to the server (10).

The storage unit (102) stores recipes information transmitted from the transmission and reception unit (101), amount of various seasoning stored at the automatic seasoning dispensing unit (104), users' own recipes information input by users and a using history like a using frequency of the recipes information chosen by users.

The display unit (103), a kind of monitor, displays recipe information stored at the storage unit (102), and a user can input an order on the display unit (103) because it can be one or selective combination of a touch screen, a touch pad or a keypad.

The automatic seasoning dispensing unit (104) stores various seasoning, and dispenses stored seasoning outside automatically according to the signals of the control unit (105).

The control unit (105) controls dispensing seasoning outside automatically according to recipe information chosen by a user among recipes information displayed on the display unit (103). In other words, the control unit (105) outputs a control signal to dispense seasoning as a relevant amount stored in the automatic seasoning dispensing unit (104) based on recipe information.

The recommendation unit (106) recommends a recipe by reflecting at least one between a using frequency of recipe information which users choose and popularity of recipe information transmitted from the server (10). Therefore, the digital chef can provide an optimum recipe and users' satisfaction increase as much. At this moment, the recommendation unit (106) can also judge similarity comparing seasoning mixing ratio in the recipe information, which a user chooses, to seasoning mixing ratio in the recipe information stored at the storage unit (102). A result according to such a judgment is displayed on the display unit (103), and because a user can choose other recipes judged similar to main ingredients and seasoning mixing ratio which a user chooses on the digital chef (100), there are various choices for users.

The recommendation unit (106) can also recommend a recipe which users can cook by based on the seasoning stored in the automatic seasoning dispensing unit (104). In the case that the automatic seasoning dispensing unit (104) doesn't have necessary seasoning in a recipe which a user choose, this is for providing a user with a recipe able to cook using remaining seasoning.

Meanwhile, a user can buy ingredients needed in a chosen recipe on a digital chef portal site. To achieve this, the transmission and reception unit (101) transmits a request of buying the relevant ingredients in recipe information chosen by a user to the server (10), and receives a paying request according to a buying request from the server (10). And the display unit (103) displays a breakdown of buying when the payment is completed according to the received paying request. Thus, a user doesn't have to operate other devices in order to buy ingredients or goods needed to cook, and a user has convenient advantage because they can confirm a breakdown of buying or state of an order immediately on the digital chef (100).

Meanwhile, as illustrated in FIG. 2 and FIG. 3, the automatic seasoning dispensing unit comprises the base unit (200), the rotating unit (300) to rotate on the base unit (200) and the case (110) to cover the base unit (200) and the rotating unit (300).

The case (110), sub material of the last exterior, comprises dry and wet type seasoning dispensing hole (111) to dispense dry type seasoning contained no water such as sugar and salt and wet type seasoning contained a little of water such as soybean paste and red pepper paste at the center, and liquid spice dispensing hole (112) to dispense liquid spice such as starch syrup, oil, soy sauce and vinegar.

Dry and wet type seasoning dispensing hole (111), as illustrated in FIG. 2, is one hole, and the liquid spice dispensing hole (112) is the same number of the liquid spice container's (210) number.

The base unit (200), as illustrated in FIG. 3, has a spice dispensing unit to discharge liquid spice, and the spice dispensing unit of the present invention includes a liquid spice container (210).

The liquid spice container (210) is transparent or opaque. It is installed on the base unit (200) by regular intervals in the circumferential direction. Two linking ports (211) (212) penetrate and are installed at each top, namely a lid part, of a liquid spice container (210).

Of the linking ports, one is a linking port of entrance (211), and the other is a linking port of exit (212). The linking port of exit (212) is connected with a supply hose (214) and a discharge hose (213) made of flexible material as illustrated in FIG. 4.

the supplying hose (214) is coupled to the linking port of exit (212) and the liquid spice discharge hole (112) of the case (110) respectively. The discharge hose (213) made of flexible material, placed at the inside of the liquid spice container (210), and coupled to the linking port of exit (212) is installed close to the inner bottom of the liquid spice container (210) in order to be able to discharge the liquid spice fully.

And an air pump (220) is installed at the center of the liquid spice container (210), as illustrated in FIG. 5, the linking port (221) is coupled to the top of the air pump (220). And, the first air hose (222) which links between the air pump (220) and the solenoid valve (230) is installed at the linking port (221). In addition, the motor (233) to activate the air pump (220) is installed at the lower part of the air pump (220).

A solenoid valve (230) coupled to the air pump (220) by the first air hose (222) has the one entrance port (231) and the several exit ports (232), and the number of the exit ports (232) are more than the number of the liquid spice containers (210). And the exit port (232) and the linking port on of entrance (211) in the liquid spice container (210) are coupled by the second air hose (233). The solenoid valve (230) sends the air supplied from the entrance port (231) to the exit port (232) coupled to the relevant liquid spice container (210) by the control unit (105) and then supplies the air to the relevant liquid spice container (210).

A rotation unit (300); a cylinder of which the center is empty, is installed on the upper side of the base unit (200), being able to rotate. The plural spice containers (310) storing dry and wet type seasoning are mounted at the outside of the rotation unit, being able to attach and detach, by regular intervals in the circumferential direction. A screw shaft (320) is installed at the seasoning container (310), being able to rotate, so that it makes the spice container (310) open and close and dispenses seasoning in the container to the outside.

Hereinafter, an operation of liquid spice discharge apparatus in the digital chef applied in the present invention.

First, when a user chooses a recipe, the digital chef's (100) control unit (105) operates the spice discharge apparatus and supplies the various relevant spices according to the main ingredients of the recipe chosen by the user automatically in order.

Specially, in the liquid spice discharging process following the present invention as illustrated in FIG. 5, the air, illustrated as a dotted line arrow, generated by the air pump (220) is supplied to the solenoid valve (230) through the first air hose (222). The air supplied to the solenoid valve (230) is just discharged to the relevant exit port (232) coupled to the liquid spice container (210) storing the relevant spice among the several exit ports (232) by the control unit (105).

And, the air output from the solenoid valve (230) is supplied to the inside of the liquid spice container (210) through the second air hose (233). The liquid spice is discharged to the outside as the same amount; volume, of the supplied air, and the liquid spice, illustrated as a line arrow, discharged from the liquid spice container (210) is discharged and supplied through the supplying hose (214) to the liquid spice discharging hole (112) of the case (110).

Therefore, a liquid spice is discharged as the same amount; volume, of the air supplied to the inside of the liquid spice container (210) as noted above so that a more accurate amount of spice can be discharged if the amount of supplied air can be controlled by the control and operation of the air pump (220) through the control part (105).

When one liquid spice is finished to be discharged, the control unit (105) controls the solenoid valve (230) and makes the air discharged at another exit port (232) so that other kind of relevant spice in a recipe can be discharged consecutively.

What is claimed is:

1. A liquid spice discharge apparatus of a cooking guide system linked with the internet that includes a digital chef providing continuously updated recipe information, and an automatic seasoning dispensing unit for storing and automatically dispensing seasonings to the outside, wherein the cooking guide system linked with the internet comprises: an air pump installed at the digital chef; a solenoid valve coupled to the air pump to change a direction of supplied air; a liquid spice container to keep a liquid spice, and coupled to the solenoid valve so that air is supplied; a discharge hose penetrating and installed at the spice container so as to discharge and supply a liquid spice by the air supplied into the spice container.

2. A liquid spice discharge apparatus of a cooking guide system linked with the internet of claim 1, wherein a more exit ports than the spice containers are installed at the solenoid valve.

3. A liquid spice discharge apparatus of a cooking guide system linked with the internet of claim 1, wherein the air pump, the solenoid valve and the spice container are coupled to each other by a flexible hose.

4. A liquid spice discharge apparatus of a cooking guide system linked with the internet of claim 1, wherein the discharge hose is installed close to the bottom of the inside in the spice container.
